(19) United States
(12) Patent Application Publication
(10) Pub. No.: US 2005/0092309 A1
(43) Pub. Date: May 5, 2005

(54) Blowby gas separation system

(76) Inventors: Maciej Bedkowski, Peterborough (GB); Deforest Gould, Washington, IL (US)

Correspondence Address: CATERPILLAR INC.;100 N.E. ADAMS STREET, PATENT DEPT., PEORIA, IL, 616296490, US

(21) Appl. No.: 10/700,162

(22) Filed: Nov. 3, 2003

(51) Int. Cl. F02B 25/06

(52) U.S. Cl. 123/572

(57) ABSTRACT

Known oil separators in blowby gas separation systems tend to be quite bulky and require significant space. The disclosed blowby gas separation system obviates this problem by providing a blowby gas separation system for an internal combustion engine which comprises a blowby gases transfer passage which is located externally of the engine and which is adapted to collect blowby gases from the engine, and a collection unit in fluid communication with the transfer passage and adapted to receive the blowby gases from the transfer passage and separate condensed oil from the blowby gases. The blowby gas transfer passage includes condensing media for condensing oil from the blowby gases. Also described is a method of re-circulating blowby gases from an internal combustion engine which includes the step of passing the blowby gases through condensing media in the transfer passage to condense oil from the blowby gases.

### TECHNICAL FIELD

This disclosure relates to a blowby gas separation system for internal combustion engines having a closed or open crankcase breather system. The disclosure also relates to a method of re-circulating blowby gases produced by such internal combustion engines.

### BACKGROUND

During the normal functioning of an engine, blowby gases escape from the combustion chambers and pass into the crankcase. These blowby gases, which are loaded with unburned gaseous hydrocarbons, are generally re-circulated back into an engine air intake through a closed breather system. Alternatively, the blowby gases may be released into the environment as in the open crankcase ventilation systems. However, blowby gases also include an oil element in the form of a fine oil mist. In certain conditions, this oil mist passing through the engine intake system may cause damage to the engine and may result in the production of undesirable pollutants. For open crankcase ventilation systems, the oil mist may be present in the blowby gases released into the environment. Thus, oil needs to be separated from the blowby gases prior to re-circulation of the blowby gases to the engine or release into the environment.

U.S. Pat. No. 5,479,907 describes a closed crankcase blowby gases separation system in which blowby gases are taken off the top of the engine and transferred through a blowby gas transfer tube to a pre-separator, and then to a separator, before the separated oil is re-circulated to the engine and the separated gases are re-circulated to the air intake. The pre-separator comprises a housing having a plurality of internal baffles defining a tortuous path around which the gases must pass. The separator comprises an annular housing which provides a further tortuous path through which the gases must pass. Both the separator and pre-separator function to condense oil from the blowby gases. A problem with the apparatus disclosed in this Patent is that the size of the separator and pre-separator often precludes their use in many types of engines where available engine space for such components is severely limited. A further problem with this apparatus is the cost of manufacture due to the use of both a separator and a pre-separator and the complexity of each. A further problem is the disposition of the blowby gases transfer passage, which could lead to condensed oil falling back into the engine.

This disclosure is directed toward overcoming one or more of the problems identified above.

### SUMMARY OF THE DISCLOSURE

According to one aspect, a blowby gas separation system for an internal combustion engine comprises a blowby gas transfer passage located externally of the engine and adapted to collect blowby gases from the engine. Condensing media in the transfer passage is adapted to condense oil from the blowby gases. A collection unit in fluid communication with the transfer passage and adapted to receive the blowby gases from the transfer passage and separate condensed oil from the blowby gases.

According to another aspect, a method of re-circulating blowby gas from an internal combustion engine comprises the steps of transferring blowby gas from the engine into a blowby gas transfer passage located externally of the engine, passing the blowby gases through condensing media in the transfer tube to condense oil from the blowby gases, collecting the condensed oil and the blowby gases from the transfer passage in a collection unit, and separating the condensed oil and the blowby gases in the collection unit.

Other aspects and features of this disclosure will be apparent from the following description and the accompanying drawings.

### BRIEF DESCRIPTION OF THE DRAWINGS

FIG. 1 is an end view of an internal combustion engine including a blowby gas separation system.

FIG. 2 is a detailed view of part of a transfer passage forming part of the blowby gas separation system of FIG. 1.

FIG. 3 is a sectional view of a collection unit.

FIG. 4 is a perspective view of a top of a gas re-circulation line;

FIGS. 5a to 5c are sectional views of collection units according to alternative embodiments.

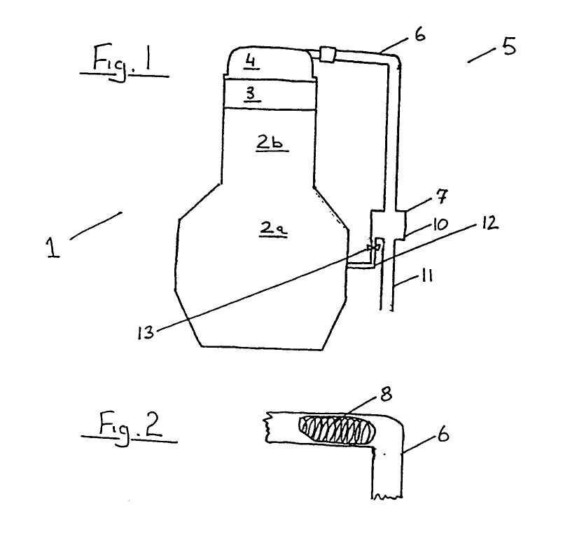

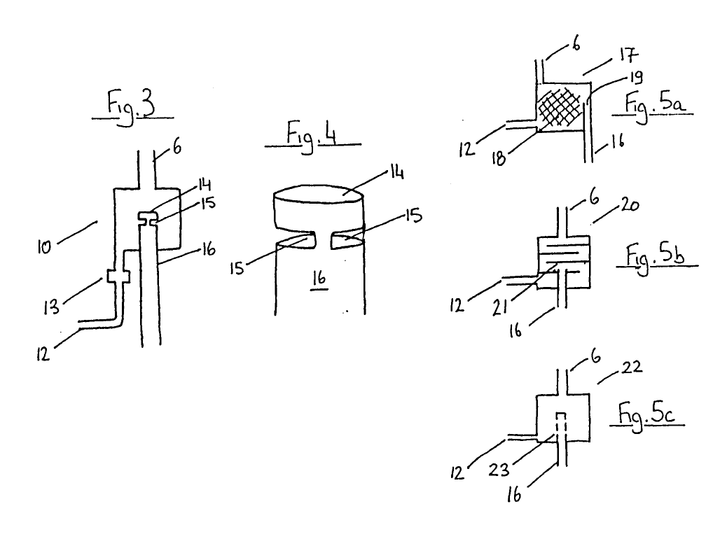

### DETAILED DESCRIPTION

The drawings illustrate an internal combustion engine 1 comprising a cylinder block 2a, a crankcase 2b, a cylinder head 3, a cylinder head cover 4, and a blowby gas separation system indicated generally by the reference numeral 5. The embodiment shown is suitable for closed crankcase breather systems but may also be used with open crankcase breather systems.

The separation system 5 includes a blowby gas transfer passage 6, in this embodiment in the form of a tube, which receives blowby gases from the engine 1 and transfers the gases to a collection unit 7. The transfer tube 6 is located externally of, and extends vertically down a side of, the engine 1. As is best illustrated in FIG. 2, the transfer tube 6 includes a condensing media in the form of a metal helical coil 8 which extends along an inside of the tube 6 along most of its length. The metal helical coil 8 also helps to prevent collapsing of the transfer pipe 6.

The collection unit 7 comprises a housing 10 suitably formed of metal or a composite material, a gas re-circulation line 11 which projects through a base of the housing 10, and an oil re-circulation line 12 which provides fluid communication between the base of the housing 10 and the crankcase 2. While in the embodiment the oil is returned to the engine, it should be appreciated that a reservoir for storing the separated oil, which may be emptied at regular service intervals, may be included.

The oil re-circulation line 12 includes a one way float valve 13 located adjacent the housing 10. However, it should be appreciated that the float valve 13 may be replaced with any other type of valve that would function to close the oil re-circulation 12 when the line is dry. Moreover, the valve may be omitted completely. The gas re-circulation line 11 comprises a hollow tube having a closed top 14 and openings 15 formed in a sidewall 16 of the tube adjacent the top 14. The tube is disposed within the housing 10 such that the openings 15 are located intermediate a top and bottom of the housing 10. The gas re-circulation line 11 provides for fluid communication between the collection unit 7 and the engine air intake system (not shown).

Referring to FIG. 5a, there is illustrated a collection unit 17 according to an alternative embodiment and in which parts similar to those identified with reference to the previous embodiments are assigned the same reference numerals. In this embodiment, the collection unit 17 includes oil condensation media in the form of a wire mesh 18. Additionally, the gas re-circulation line 11 has an open top 19.

Referring to FIG. 5b, there is illustrated a collection unit 20 according to an alternative embodiment and in which parts similar to those identified with reference to the previous embodiments are assigned the same reference numerals. In this embodiment, the collection unit 20 includes oil condensation media in the form of a plurality of baffles 21.

Referring to FIG. 5c, there is illustrated a collection unit 22 according to an alternative embodiment and in which parts similar to those identified with reference to the previous embodiments are assigned the same reference numerals. In this embodiment, a part of the gas re-circulation line 11 located within the housing 10 has a perforated sidewall 23.

In this specification, the condensing media in the blowby gases transfer tube 6 is described as being a helical coil 8. However, it should be understood that various other types and forms of media may be used such as, for example, wire mesh, an insert providing a tortuous path, baffles, filter material such as polyester fiber and other types of filter material.

It will be further appreciated that while the embodiments described above show the oil re-circulation line 12 communicating with the crankcase 2, the line 12 may alternatively communicate with an oil sump of the engine.

### Industrial Applicability

In use, blowby gases which collect under the cylinder head cover 3 pass into the transfer tube 6 and pass through the helical coil 8 where some of the oil mist within the gases condenses on a large surface area of the coil 8 into droplets which eventually pass under gravity into the collection unit 7. The blowby gases, which have been at least partially depleted of oil, also pass into the collection unit 7 from where they are transferred back to an engine air intake system through the gas re-circulation line 11. Oil which collects in the collection unit 7 is permitted to pass into the crankcase 2 through the oil re-circulation line 12. However, when there is little oil in the collection unit 7, the float valve 13 closes the oil re-circulation line 12 thereby preventing the flow of gases from the crankcase 2.

The blowby gases separation system 5 is designed for taking blowby gases off an engine 1, removing oil from these gases, and returning the oil-depleted gases to the engine induction system. In the embodiments described, the blowby gas transfer passage 6 communicates with the cylinder head cover 4 and runs down the side of the engine, externally. The oil re-circulation line 12 communicates with the crankcase 2. Although it is not illustrated in the Figures, the gas re-circulation line 11 communicates with the engine air intake system.

The use of a blowby gases transfer passage 6 having condensing media contained therein obviates the need for large, bulky and complicated separators, thereby reducing the space required for the engine 1. The disposition of the transfer passage 6 above the collection unit 7 ensures that any oil condensed in the transfer passage 6 falls down into the collection unit 7, thereby preventing any condensed oil falling back into the engine 1. The location of the transfer passage 6 externally of the engine 1 has the effect of lowering the temperature of the separation media thereby improving the separation media efficiency. Separation of oil from the blowby gases is enhanced as the blowby gases impact with walls of the collection unit housing 10. Further enhancement of separation is achieved by inclusion of condensing media in the collection unit 7.

Although preferred embodiments have been described herein, improvements and modifications may be incorporated without departing from the scope of the following claims.

1. A blowby gas separation system for an internal combustion engine comprising:
a blowby gas transfer passage located externally of the engine and adapted to collect blowby gases from the engine;
condensing media in the transfer passage adapted to condense oil from the blowby gases; and
a collection unit in fluid communication with the transfer passage and adapted to receive the blowby gases from the transfer passage and separate condensed oil from the blowby gases.

2. The blowby gas separation system of claim 1 including an oil re-circulation line in fluid communication with the collection unit and adapted to return the separated condensed oil to the engine.

3. The blowby gas separation system of claim 1 including a reservoir for storing the separated condensed oil.

4. The blowby gas separation system of claim 1 in which the blowby gases transfer passage is disposed with respect to the collection unit such that condensed oil in the transfer tube will pass under gravity into the collection unit.

5. The blowby gas separation system of claim 1 in which the condensing media comprises a helical coil extending along at least a portion of the transfer passage.

6. The blowby gas separation system of claim 2 in which the condensing media comprises a helical coil extending along at least a portion of the transfer passage.

7. The blowby gas separation system of claim 1 in which the condensing media comprises a wire mesh extending along at least a portion of the transfer passage.

8. The blowby gas separation system of claim 1 in which the condensing media comprises a wire mesh extending along at least a portion of the transfer passage.

9. The blowby gas separation system of claim 1 in which the collection unit includes condensing media.

10. The blowby gas separation system of claim 1 further including a gas re-circulation line for re-circulating separated gases from the collection unit to an engine air intake system.

11. The blowby gases separation system of claim 2 in which the oil re-circulation line includes a valve adapted to prevent blowby gases exiting the engine through the oil recirculation line.

12. The blowby gases separation system of claim 2 in which the collection unit comprises a housing having a top and a base, a mouth of the oil re-circulation line being located adjacent a base of the housing, and wherein a mouth of the gas re-circulation line is located intermediate a top and base of the housing.

13. The blowby gases separation system of claim 11 in which the collection unit comprises a housing having a top and a base, a mouth of the oil re-circulation line being located adjacent a base of the housing, and wherein a mouth of the gas re-circulation line is located intermediate a top and base of the housing.

14. A method of separating oil from blowby gases produced by an internal combustion engine comprising the steps of:
transferring blowby gases from the engine Into a blowby gas transfer passage located externally of the engine;
passing the blowby gases through condensing media in the transfer passage to condense oil from the blowby gases;
collecting the condensed oil and the blowby gases from the transfer passage in a collection unit; and
separating the condensed oil and the blowby gases in the collection unit.

15. The method of claim 14 including the step of re-circulating the condensed oil to the engine.

16. The method of claim 14 including the step of storing the separated condensed oil in a reservoir.

17. The method of claim 14 including the step of re-circulating separated blowby gases from the collection unit to an engine air intake system.

18. The method of claim 14 including the steps of re-circulating the condensed oil to the engine and re-circulating separated blowby gases from the collection unit to an engine air intake system.

19. The method of claim 14 including the steps of storing the separated condensed oil in a reservoir and re-circulating separated blowby gases from the collection unit to an engine air intake system.

20. A gas separation system for an internal combustion engine comprising:
a gas transfer passage located externally of the engine and adapted to collect gases from the engine;
means in the transfer passage for condensing oil from the gases; and
a collection unit in fluid communication with the transfer passage and adapted to receive the gases from the transfer passage and separate condensed oil from the gases.

21. A blowby gas separation system for an internal combustion engine comprising:
a blowby gas transfer passage located externally of the engine and adapted to collect blowby gases from the engine; and
condensing media in the transfer passage adapted to condense oil from the blowby gases;
wherein both blowby gases and condensed oil exiting the condensing media travel within the transfer passage in a common direction away from the condensing media.

22. The blowby gas separation system of claim 21 further comprising a collection unit in fluid communication with the transfer passage and adapted to receive the blowby gases from the transfer passage and separate condensed oil from the blowby gases.
